(19) United States
(12) Patent Application Publication
(10) Pub. No.: US 2020/0071960 A1
(43) Pub. Date: Mar. 5, 2020

(54) DOOR LOCK AND BALLISTIC DOOR SAFETY SYSTEM INCLUDING SAME

(71) Applicant: G.R.P. Mechanical Company, Inc., Bethalto, IL (US)

(72) Inventor: Mark Wayne Wadlow, Godfrey, IL (US)

(21) Appl. No.: 16/119,459

(22) Filed: Aug. 31, 2018

(51) Int. Cl. E05B 53/00

(52) U.S. Cl. CPC E05B 53/001; F41H 5/0485

(57) ABSTRACT

A door lock includes a base and a lock bar moveably coupled to the base. The base includes an angled top wall and a bottom wall, and has at least one channel defined therein. The lock bar includes at least one rod having a first end coupled to the lock bar and a second end that extends into the at least one channel. The lock bar further includes a top wall and an angled bottom wall that is oriented at substantially the same angle as the base top wall such that the base top wall and lock bar bottom wall are substantially parallel to one another. The lock bar is moveable relative to the base from a first position to a second, engaged position, in which the second end of the at least one rod protrudes from the base bottom wall.

### BACKGROUND

The field of the disclosure relates generally to door locks, and more specifically, to foot-activated door locks and ballistic door safety systems including the same.

There are many situations in which it is desirable to securely lock a door, such as for safety reasons. Many doors include locks on or adjacent to their handles. However, in at least some cases, these locks can be broken (e.g., with an application of force on the handle) or otherwise bypassed, allowing the door to be opened about its hinges. Additionally, at least some known supplementary door locks are prone to failure and/or require multiple pieces or steps to activate the door lock.

### BRIEF DESCRIPTION

A door lock includes a base configured to be coupled to a door and a lock bar moveably coupled to the base. The base includes an angled top wall and a bottom wall, and has at least one channel defined therein extending from the top wall to the bottom wall. The lock bar includes at least one rod having a first end coupled to the lock bar and a second end that extends into the at least one channel. The lock bar further includes a top wall and an angled bottom wall. The lock bar bottom wall is oriented at substantially the same angle as the base top wall such that the base top wall and lock bar bottom wall are substantially parallel to one another. The lock bar is moveable relative to the base from a first, disengaged position, in which the lock bar is spaced from the base, to a second, engaged position, in which the lock bar bottom wall engages the base top wall, and the second end of the at least one rod protrudes from the base bottom wall.

A ballistic door safety system includes a ballistic panel assembly and a door lock. The ballistic panel assembly includes a plurality of ballistic layers, and is configured to be coupled to a first surface of a door. The door lock includes a base configured to be coupled to the ballistic panel assembly and a lock bar moveably coupled to the base. The base includes an angled top wall and a bottom wall, and has at least one channel defined therein extending from the top wall to the bottom wall. The lock bar includes at least one rod having a first end coupled to the lock bar and a second end that extends into the at least one channel. The lock bar further includes a top wall and an angled bottom wall. The lock bar bottom wall is oriented at substantially the same angle as the base top wall such that the base top wall and lock bar bottom wall are substantially parallel to one another. The lock bar is moveable relative to the base from a first, disengaged position, in which the lock bar is spaced from the base, to a second, engaged position, in which the lock bar bottom wall engages the base top wall, and the second end of the at least one rod protrudes from the base bottom wall.

### BRIEF DESCRIPTION OF THE DRAWINGS

FIG. 1 is a perspective view an exemplary door lock, shown in a disengaged or unlocked position.

FIG. 2 is a perspective view of the door lock of FIG. 1, shown in an engaged or locked position.

FIG. 3 is an exploded view of the door lock of FIG. 1.

FIG. 4A is a front view of the door lock of FIG. 1, shown in the disengaged position.

FIG. 4B is a sectional view of the door lock of FIG. 1 taken along line A-A in FIG. 4A.

FIG. 5 is another sectional view of the door lock of FIG. 1 taken along line A-A in FIG. 4A, showing activation of the door lock by a user's foot.

FIG. 6A is a front view of the door lock of FIG. 1, shown in the engaged position.

FIG. 6B is a sectional view of the door lock of FIG. 1, taken along line “A-A” in FIG. 6A.

FIG. 7 is an exploded view of an exemplary ballistic door panel assembly.

FIG. 8 is a sectional view of the ballistic door panel assembly of FIG. 7 coupled to a door.

FIG. 9 is a front view of the ballistic door panel assembly of FIG. 7 installed on the door.

FIG. 10 is a front view of an exemplary ballistic door safety system including the lock assembly of FIG. 1 and the ballistic door panel assembly of FIG. 7.

### DETAILED DESCRIPTION

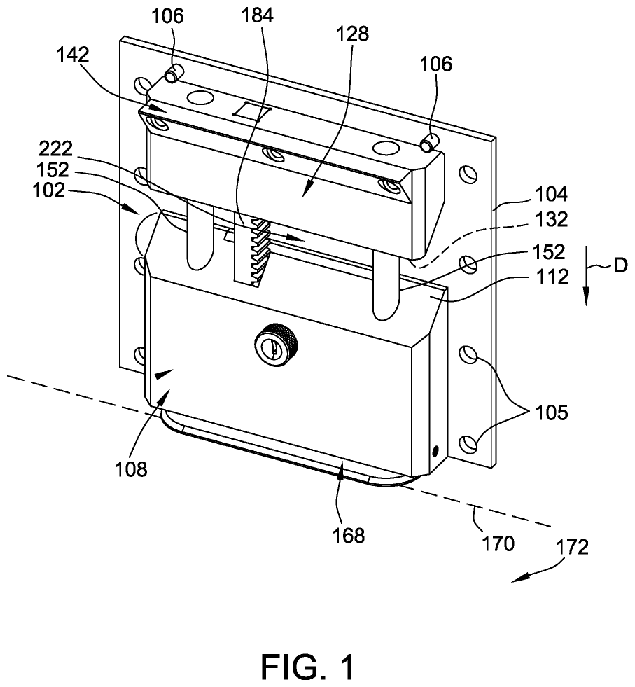

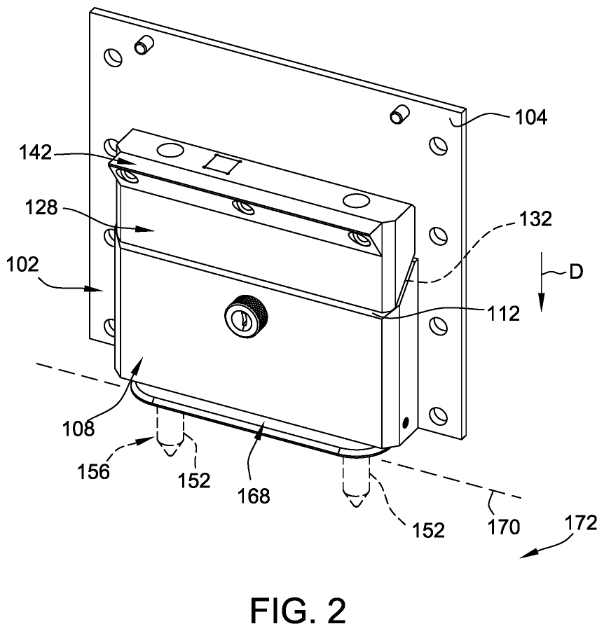

FIG. 1 is a perspective view of an exemplary door lock 102 shown in a disengaged or unlocked position. FIG. 2 is a perspective view of the door lock 102 shown in an engaged or locked position. As described in further detail herein, the door lock 102 is configured to be coupled to a door and, when activated, securely lock the door in place to prevent the door from being opened.

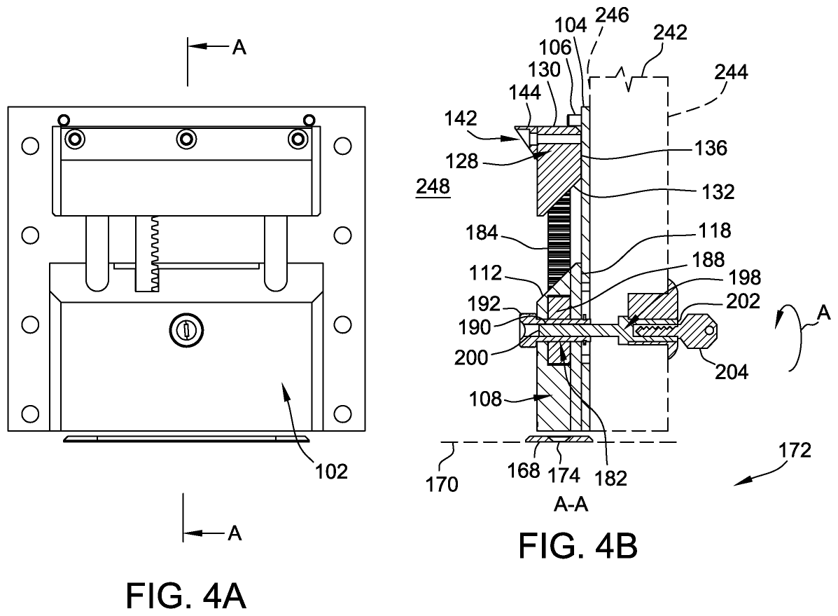

In the exemplary embodiment, the door lock 102 includes a mounting plate 104 for mounting the door lock 102 to a door (e.g., door 242 shown in FIG. 4B), a base 108 coupled to the mounting plate 104, a lock bar 128 moveably coupled to the base 108, and a floor plate 168. The door lock 102 further includes at least one rod 152 fixed to the lock bar 128 and extending into the base 108. As shown in FIGS. 1 and 2, when the door lock 102 is activated or moved from the disengaged position to the engaged position, the lock bar 128 and the at least one rod 152 move downward with respect to base 108 such that the at least one rod 152 protrudes from the bottom of the base 108 and extends through the floor plate 168 and into the floor 172, thereby preventing the door to which the door lock 102 is mounted from being opened.

The mounting plate 104 is used to secure the base 108 to a door. Specifically, the mounting plate 104 has a plurality of fastener openings 105 defined therein for receiving a plurality of fasteners and securing the mounting plate 104, and thereby the base 108 and remainder of door lock 102, to a door. In the illustrated embodiment, the mounting plate 104 also includes two stop pins 106 for limiting or stopping upward movement of the lock bar 128.

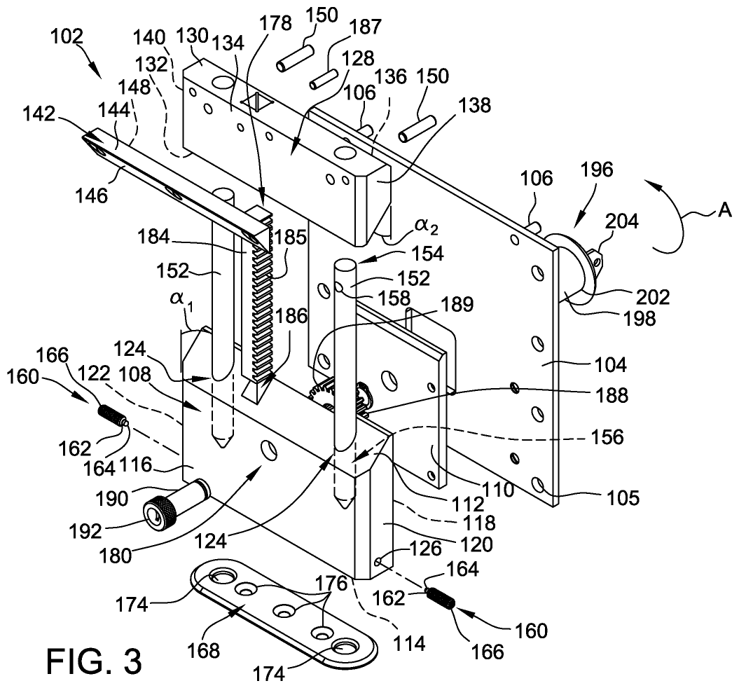

With additional reference to FIG. 3, the base 108 includes an angled top wall 112, a bottom wall 114, a front wall 116, a back wall 118, a first side wall 120, and a second side wall 122. The front wall 116 and the back wall 118 are substantially parallel to one another, and the first side wall 120 and the second side wall 122 are substantially parallel to one another. The top wall 112 extends from the back wall 118 to the front wall 116 at a first oblique angle α₁ relative to the front wall 116. In the exemplary embodiment, two channels 124 are defined through the base 108 extending from the top wall 112 to the bottom wall 114. One channel 124 is generally adjacent the first side wall 120, and the other channel 124 is generally adjacent the second side wall 122. In other embodiments, the base 108 may have more than or less than two channels defined therethrough. In some embodiments, for example, the base 108 has only one channel 124 defined therethrough. In other embodiments, the base 108 has more than two channels 124 defined therethrough. The base 108 also defines two pockets 126, each extending inward from a respective side wall 120, 122, and to a respective one of the channels 124.

The lock bar 128 includes a top wall 130, an angled bottom wall 132, a front wall 134, a back wall 136, a first side wall 138, and a second side wall 140. The front wall 134 and the back wall 136 are substantially parallel to one another, and the first side wall 138 and the second side wall 140 are substantially parallel to one another. The bottom wall 132 extends from the back wall 136 to the front wall 134 of the lock bar 128 at a second oblique angle α₂ relative to the back wall 136. In the exemplary embodiment, the second angle α₂ of the lock bar 128 is the same as the first angle α₁ of the base 108, such that the lock bar bottom wall 132 is parallel to the base top wall 112 and, when the lock bar 128 is engaged with the base 108 (as described further herein), the lock bar bottom wall 132 sits flush against the base top wall 112. Additionally, in the exemplary embodiment, a foot plate extension 142 is coupled to the lock bar 128. The foot plate extension 142 includes a top wall 144, a front wall 146, and a back wall 148. In the exemplary embodiment, the back wall 148 of the foot plate extension 142 is coupled to the front wall 134 of the lock bar 128 with fasteners 150. In other embodiments, the foot plate extension 142 is coupled to the top wall 144 of the lock bar 128. In yet other embodiments, the foot plate extension 142 may be formed integrally with the lock bar 128.

In the exemplary embodiment, the door lock 102 includes two rods 152, each including a respective first end 154 and a respective second end 156. Each of the first ends 154 includes a fastener opening 158 for receiving one of fasteners 150 therein. The first ends 154 of the rods 152 are coupled to the lock bar with the fasteners 150. Specifically, the fasteners 150 extend through the front wall 146 of the foot plate extension 142, through the front wall 134 of the lock bar 128, and through the fastener openings 158 of the rods 152 to couple the foot plate extension 142 and the rods 152 to the lock bar 128. In the exemplary embodiment, rods 152 are generally cylindrical in shape and are shaped complementary to the cylindrical channels 124. Further, in the exemplary embodiment, the second ends 156 of the rods 152 are generally conical in shape and are configured to extend or pass through the channels 124 of the base 108. In other embodiments, rods 152 and channels 124 may have any suitable complementary size and shape that enables door lock 102 to function as described herein.

The door lock 102 further includes two pins 160, each extending through a respective one of the pockets 126 of the base 108. Each of the pins 160 includes a first end 162 and a second end 166. Each first end 162 is defined by a ball detent 164. When the pins 160 are inserted into the pockets 126 of the base 108, the ball detents 164 are engaged with the second ends 156 of the respective rods 152, and the second ends 166 of the pins 160 are substantially flush with one of the respective side walls 138, 140 of the base 108.

The floor plate 168 is configured to be coupled to a surface 170 of a floor or ground 172. The floor plate 168 has rod apertures 174 and fastener openings 176 defined therein. The rod apertures 174 are sized and shaped complementary to the rods 152 such that the rods 152 can extend through the rod apertures 174, through the surface 170, and into the ground 172, as described in more detail below. The fastener openings 176 are configured to receive screws or other fasteners (not shown) that extend into the ground 172 to couple the floor plate 168 to the surface 170.

In the exemplary embodiment, the door lock 102 further includes a conveyor mechanism 178 that enables the lock bar 128 to be moved relative to the base 108, and to transition the door lock 102 from the engaged position (shown in FIG. 2) to the disengaged position (shown in FIG. 1). The conveyor mechanism 178 includes a toothed rack 184 having slots 185 defined therein, and a gear or pinion 188 that includes teeth 189. A conveyor shaft channel 180 is defined in the base 108 and extends from the front wall 116 to the back wall 118 of the base 108. A cavity 182 (shown in FIG. 4B) is defined in the back wall 118 of the base 108 and is configured to at least partially receive the gear 188. A conveyor channel 186 is defined through the base 108 from the top wall 112 to the bottom wall 114 and is generally parallel to the channels 124. The toothed rack 184 is coupled to the lock bar 128 via fastener 187, and extends through the conveyor channel 186 of the base 108. A conveyor shaft 190 extends through the conveyor shaft channel 180 and defines an axis of rotation for the gear 188. A plate 110 encloses the toothed rack 184 and the conveyor shaft 190 within the base cavity 182. The gear 188 is coupled to and co-axial with the conveyor shaft 190 and is rotatable with respect to the toothed rack 184. The teeth 189 of the gear 188 are configured to mesh with the slots 185 of the toothed rack 184 and, upon rotation of the gear 188, cause linear movement of the toothed rack 184. The conveyor shaft 190 includes a knob 192 that abuts the front wall 116 of the base 108.

In the exemplary embodiment, the door lock 102 further includes an unlock mechanism 196 that includes a key shaft 198, a first end 200, a second end 202, and a removable key 204. The key shaft 198 extends from the first end 200 to the second end 202. The first end 200 of the key shaft 198 is positioned within an interior of the conveyor shaft 190, intermediate the base front wall 116 and back wall 118, and the second end 202 of the key shaft 198 is positioned on an opposite side of the mounting plate 104 and is configured to accept the key 204. When the door lock 102 is mounted to the door 242 (see FIG. 4B), the second end 202 of the key shaft 198 extends through the door 242. The first end 200 is positioned on inner or interior side of the door 242, and the second end 202 is outside of the door 242 (i.e., adjacent to the exterior surface 244 of the door 242). The key shaft 198 is coupled to and co-axial with the conveyor shaft 190. The key 204 is configured to operate the key shaft 198 such that rotation of the key 204 in the direction of arrow A causes rotation of key shaft 198 and corresponding rotation of the conveyor shaft 190 and the gear 188, and corresponding movement of the toothed rack 184.

In the disengaged position (shown in FIG. 1), the door lock 102 is configured such that the lock bar 128 is positioned above and separated or spaced from the base 108 by an open area or spacing 222 defined between the base 108 and the lock bar 128. The rods 152 and the toothed rack 184 are visible or accessible within the spacing 222. The orientation or angle of base top wall 112 and lock bar bottom wall 132 inhibits debris or other foreign objects from settling within the spacing 222, which might otherwise prevent proper operation of the door lock 102.

Further, in the disengaged position (shown in FIG. 1), the ball detent 164 of each pin 160 (shown in FIG. 3) engages the second end 156 of a respective rod 152 (shown in FIG. 3). The ball detents 164 keep the door lock 102 in the disengaged position by keeping the rods 152 in an elevated position. That is, each ball detent 164 is in contact with the second end 156 of a respective one of the rods 152, and keeps the rods 152 from moving downward in a direction D.

To transition the door lock 102 from the disengaged position (shown in FIG. 1) to the engaged position (shown in FIG. 2), a force is exerted on the lock bar 128 and/or the foot plate extension 142 in a downward direction (i.e., in the direction D). The ball detents 164 of the pins 160 retract and allow the rods 152 to move in the direction D, thereby allowing the lock bar 128 to move downward in the direction D. As the lock bar 128 moves towards the engaged position, the second ends 156 of the rods 152 extend out of the base bottom wall 114, and slide past the surface 170 and into the ground 172 through rod apertures 174 (shown in FIG. 3) of the floor plate 168. The angled top wall 112 of the base 108 and the angled bottom wall 132 of the lock bar 128 engage one another in a flush fit. Notably, because the direction D is the same direction as the force of gravity, the door lock 102 is biased toward the engaged position by the weight of the lock bar 128, rods 152, and associated components. That is, in the absence or failure of the pins 160, the door lock 102 would remain in the engaged or locked position.

FIG. 4A is a front view of the door lock 102 of FIG. 1, shown in the disengaged position. FIG. 4B is a sectional view of the door lock 102, taken along line A-A of FIG. 4A, showing the door lock 102 coupled to a door 242. The door 242 includes an exterior surface 244 and an interior surface 246 with respect to a room 248, and the door lock 102 is coupled to the interior surface 246 of the door 242. As shown in FIG. 4B, the conveyor mechanism 178 and the unlock mechanism 196 are coupled to one another via the conveyor shaft 190 and the key shaft 198. Specifically, when the door lock 102 is mounted to the door 242, the key shaft 198 extends from the door exterior 244, through the door 242, and is coupled to the conveyor shaft 190 of the conveyor mechanism 178 at the key shaft first end 200.

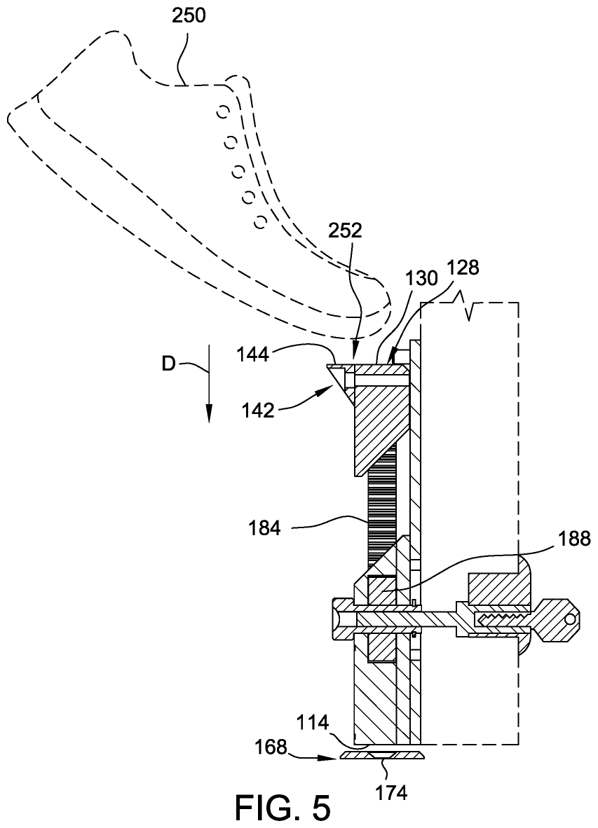

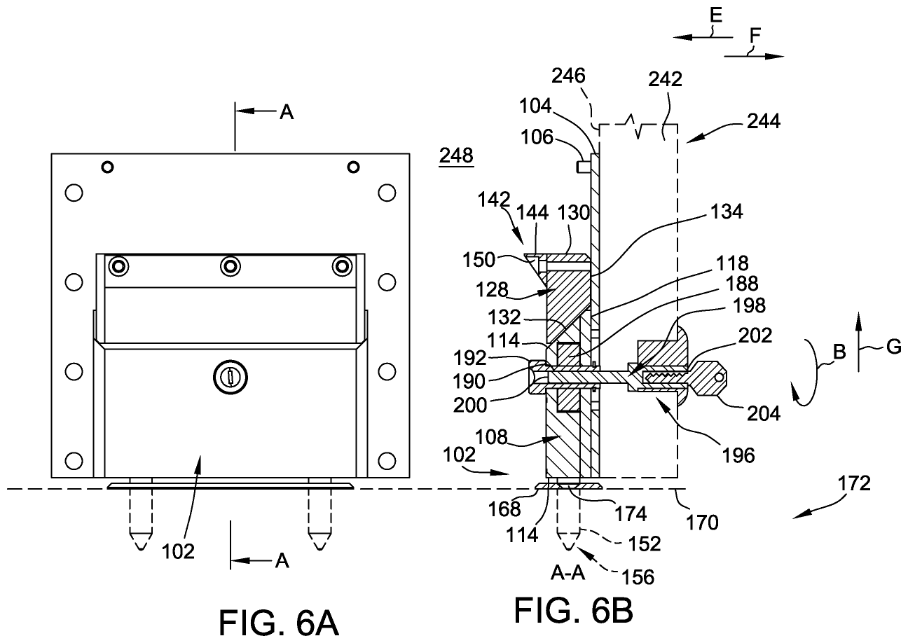

FIG. 5 is another sectional view of the door lock 102 taken along line A-A in FIG. 4A, showing activation of the door lock 102 by a user's foot 250. Specifically, to transition the door lock 102 from the disengaged position to the engaged position, the foot 250 exerts an external downward force in the direction D on the door lock 102. The foot 250 pushes downward on the top wall 130 of the lock bar 128 and the top wall 144 of the foot plate extension 142. The top walls 130 and 144 of the lock bar 128 and the foot plate extension 142, respectively, are substantially coplanar such that the foot 250 has a generally flat engagement or strike surface 252 to engage. That is, the foot plate extension 142 serves as an extension of the top wall 130 of the lock bar 128. The foot 250 pushes down on the strike surface 252, and the lock bar 128 translates downward in the direction D until the door lock 102 is in the engaged position (shown in FIG. 6B). As described above, in operation, as the foot 250 pushes down on the strike surface 252, the rods 152 (shown in FIGS. 1 and 3) slide downward in the direction D causing the ball detents 164 of the pins 160 (shown in FIG. 1) to retract, allowing downward movement of the rods 152. The rods 152 slide downward in the direction D through the respective channels 124, through the bottom wall 114 of the base 108, and through the rod apertures 174 of the floor plate 168. Simultaneously, the toothed rack 184 of the conveyor mechanism 178 (shown in FIG. 1) translates downward, causing rotational movement of the gear 188 in the direction A.

FIG. 6A is a front view of the door lock 102, shown in the engaged position after the foot 250 pushes down on the strike surface 252. FIG. 6B is a sectional view of the door lock 102, taken along line A-A of FIG. 6A, showing the door lock 102 coupled to the door 242. In the engaged position, the second ends 156 of the rods 152 protrude from the base bottom wall 114, and extend into the ground 172 through the rod apertures 174 of the floor plate 168. In the engaged position with the rods 152 secured in the ground 172, the door lock 102 prevents the door 242 from being opened in an inward direction E or an outward direction F, depending on which direction the door 242 is configured to be opened. A force in either of the directions E or F on the exterior 244 of the door 242 would be counteracted by the rods 152 being coupled to the ground 172, and the door 242 would not move.

Once the door lock 102 is in the engaged position, the door lock 102 must be transitioned back to the disengaged position in order to open the door 242. From the interior surface 246, the door lock 102 can be transitioned to the disengaged position by exerting an upward force in the direction G (i.e., opposite to the direction D) on the foot plate extension 142 and/or the lock bar 128. Moving the foot plate extension 142 and/or the lock bar 128 in the direction G causes the toothed rack 184 (shown in FIG. 5) to move in the upward direction G, causing rotational movement of the gear 188 in a direction B. Further, moving the foot plate extension 142 in the direction G causes the rods 152 to translate upward. The rods 152 move through the rod apertures 174 of the floor plate 168 and through the bottom wall 114 of the base 108 until the conical second ends 156 of the rods 152 are engaged with the ball detents 164 of the pins 160. With the second ends 156 of the rods 152 positioned within the base channels 124, the door lock 102 is not coupled to the ground 172 and does not inhibit movement of the door 242.

From the exterior surface 244 (i.e., outside the door 242), the door lock 102 can be moved to the disengaged position only through use of the unlock mechanism 196. The key 204 is inserted into the key shaft 198 and rotation of the key 204 in the direction B causes the key shaft 198 to rotate in the direction B, causing the gear 188 to rotate in the direction B, causing the toothed rack 184 to move upward in the direction G. Upward movement of the toothed rack 184 causes the lock bar 128 to move upward, causing the rods 152 to move upward out of the floor 172 and retract into the base channels 124. In the exemplary embodiment, the key shaft 198 is configured to only accept a specific type of key that only certain entities (e.g., first responders) have access to. This configuration of the unlock mechanism 196 ensures that the door 242 is only opened from the exterior 244 by, for example, rescue workers.

Components of the door lock 102, such as the mounting plate 104, the base 108, the lock bar 128, the floor plate 168, and the rod 152, are constructed of structurally rigid materials and, in some embodiments, may provide protection from ballistic objects or projectiles. Suitable materials from which components of the door lock 102, such as the mounting plate 104, the base 108, the lock bar 128, the floor plate 168, and the rod 152, can be constructed include, for example and without limitation, steel (e.g., stainless steel), wood, and plastics. In some embodiments, the base 108 and the lock bar 128 are constructed of the same material. In other embodiments, the base 108 and the lock bar 128 are constructed of different materials.

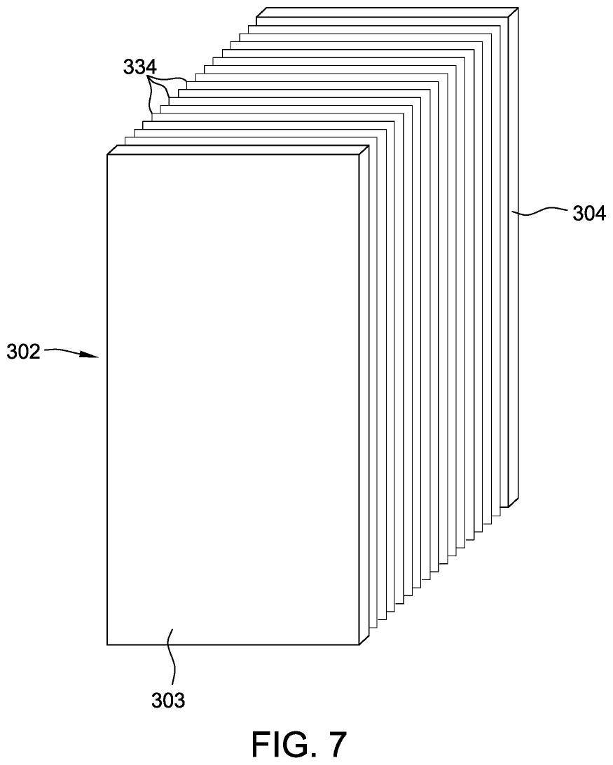

FIG. 7 is an exploded view of a ballistic door panel assembly 302 including a plurality of ballistic layers. The ballistic door panel assembly 302 is configured to be retrofitted to an existing door (e.g., door 242, shown in FIG. 4B) to provide protection for occupants of a room from ballistic objects or projectiles. In the exemplary embodiment, the ballistic door panel assembly 302 has a generally rectangular shape, corresponding to the shape of a door (e.g., door 242, shown in FIG. 4B). In other embodiments, the ballistic door panel assembly 302 can be suitably sized and shaped to fit the dimensions of any existing door, as desired.

The ballistic door panel assembly 302 includes a plurality of ballistic layers including a first ballistic panel 303, a second ballistic panel 304, and a plurality of ballistic films or sheets 334 interposed or sandwiched between the first ballistic panel 303 and the second ballistic panel 304. As used herein, the term “ballistic layer” refers to a layer of material that is capable of absorbing and dissipating energy from a high-velocity impact, such as through spall formation, tensile fiber failure, fiber de-bonding, fiber pullout, and interlayer delamination.

The first and second ballistic panels 303 and 304 are constructed of suitably rigid materials such that they are self-supporting and provide a suitably rigid structure or substrate to support the plurality of ballistic sheets 334. Suitable materials from which the first and second ballistic panels 303 and 304 can be constructed include, for example and without limitation, extruded ultra-high molecular weight polyethylene (UHMWPE), steel (e.g., stainless steel), and aluminum. The thickness of the ballistic panels 303 and 304 can vary depending on the type of material from which the ballistic panels 303 and 304 are constructed. In some embodiments, each of the ballistic panels 303 and 304 has a thickness of less than 2 inches. Particular embodiments of the ballistic door panel assembly 302 can have ballistic panels 303 and 304 with a thickness in the range of 0.125 inches to 1.5 inches, 0.125 inches to 1.0 inches, 0.125 inches to 0.75 inches, or 0.125 inches to 0.5 inches.

The ballistic sheets 334 are generally constructed of thin sheets or films having a thickness of less than 1/16 of an inch, and can be laminated together, together with or separately from the ballistic panels 303 and 304. The ballistic sheets 334 can be made of, for example, glass fibers, carbon fibers, polymer fibers, polyethylene fibers, ceramic fibers, aramid fibers (e.g., KEVLAR), ultra-high molecular weight polyethylene (UHMWPE) fibers (e.g., DURAVAR), polymeric matrix composites, and/or any combination thereof. The number of ballistic sheets 334 interposed between the first and second ballistic panels 303 and 304 can vary depending on the type of material from which the ballistic sheets 334 are constructed, and the desired level of threat protection. In some embodiments, the number of ballistic sheets 334 interposed between the ballistic panels 303 and 304 is between 1 and 50. Particular embodiments of the ballistic door panel assembly 302 can include between 5 and 25 ballistic sheets 334, between 7 and 20 ballistic sheets 334, between 7 and 15 ballistic sheets 334, between 10 and 20 ballistic sheets 334, or between 10 and 15 ballistic sheets 334.

The specific configuration of the ballistic door panel assembly 302, such as the thickness of the ballistic panels 303, 304, the number of ballistic sheets 334, and the types of materials used for the ballistic panels 303, 304 and the ballistic sheets 334 may be selected to achieve a desired level of threat protection, such as a particular National Institute of Justice (NIJ) or UL level or rating. In some embodiments, for example, the ballistic door panel assembly 302 is configured such that it meets NIJ Level IIIA or UL Level 6. In the exemplary embodiment, the ballistic door panel assembly 302 is configured to meet NIJ Level IIIA, and includes first and second panels 303 and 304 made from extruded UHMWPE, each having a thickness of 0.25 inches, and 15 ballistic sheets 334 made of KEVLAR fibers.

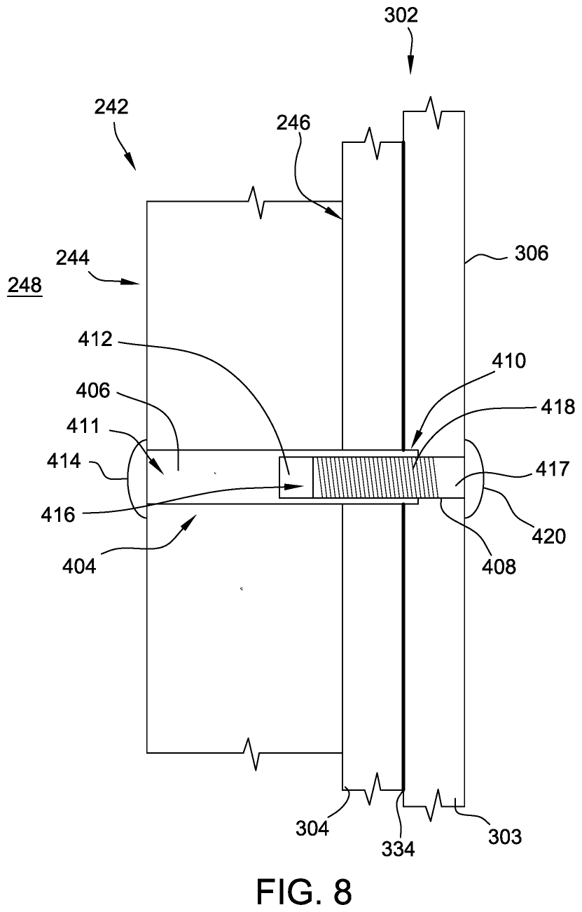

FIG. 8 is a sectional view of the ballistic door panel assembly 302 of FIG. 7 coupled to the door 242 (shown in FIG. 4B). A connection assembly 404 is configured to couple the ballistic door panel assembly 302 to the door 242. In the illustrated embodiment, the connection assembly 404 couples the ballistic door panel assembly 302 to the interior surface 246 of the door 242. In alternative embodiments, the connection assembly 404 is configured to couple the ballistic door panel assembly 302 to the exterior surface 244 of the door 242. The connection assembly 404 extends from a front wall 306 of the first panel 303, through the plurality of ballistic sheets 334 and the second panel 304, to the exterior surface 244 of the door 242. The connection assembly 404 includes a first connection device 406 and a second connection device 408. The first connection device 406 includes a first end 410 and a second end 411. The first end 410 includes an internally threaded opening 412, and the second end includes a flange 414. The second connection device 408 includes a first end 416 and a second end 417. The first end 416 includes an externally threaded portion 418, and the second end 417 includes a flange 420. The threaded portion 418 of the second connection device 408 is configured to threadably engage the threaded opening 412 of the first connection device 406, thereby securing the ballistic door panel assembly 302 to the door 242. The flange 414 of the first connection device 406 engages the exterior surface 244 of the door 242, and the flange 420 of the second connection device 408 engages the front wall 306 of the first panel 303 of the ballistic door panel assembly 302 when the first and second connection devices 406 and 408 are secured together.

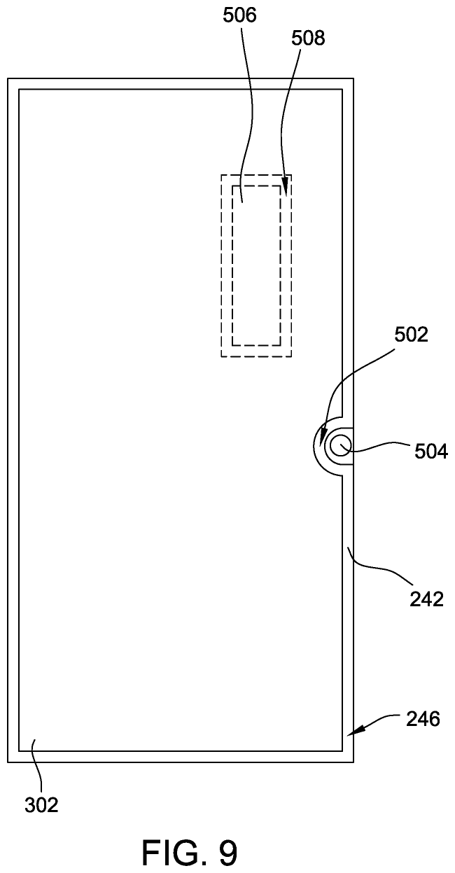

FIG. 9 is a front view of the ballistic door panel assembly 302 installed on the interior surface 246 of the door 242. In the illustrated embodiment, the ballistic door panel assembly 302 includes a cutout 502 for a door handle 504. The cutout 502 can be any shape that allows easy access to and accommodates the door handle 504. In some embodiments, the door 242 may include a window 506. When the door 242 includes the window 506, the ballistic door panel assembly 302 can include a window cutout 508 to accommodate the window 506. The window 506 and the window cutout 508 can be any shape and size. In other embodiments, the ballistic door panel assembly 302 does not include a window cutout 508.

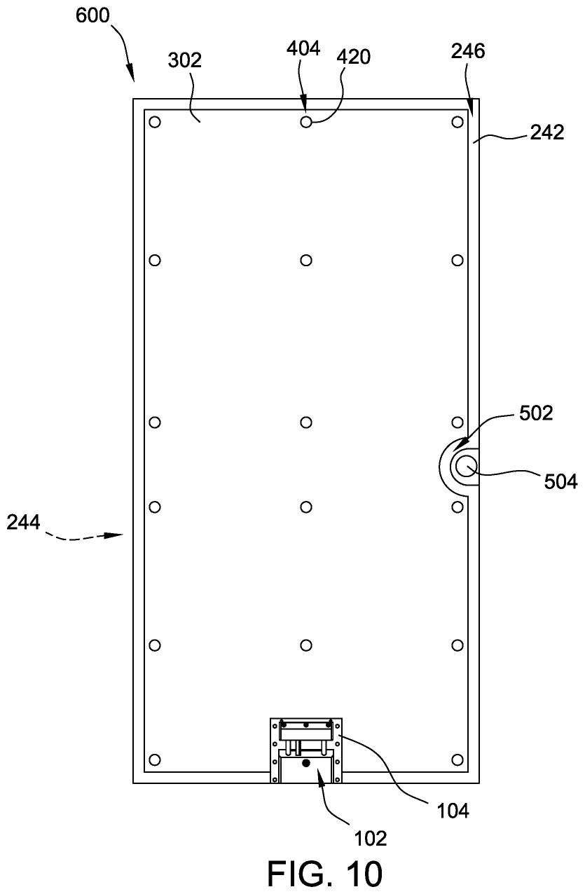

FIG. 10 is a front view of a ballistic door safety system 600 installed on the interior surface 246 of the door 242. The ballistic door safety system 600 includes the door lock 102 coupled to the ballistic door panel assembly 302, which is coupled to the interior surface 246 of the door 242. The door lock 102 is coupled to the ballistic door panel assembly 302 using fasteners (not shown) that extend through fastening holes 105 of the mounting plate 104 (shown in FIG. 1). The ballistic door panel assembly 302 is coupled to the door 242 with a plurality of the connection assemblies 404. In the exemplary embodiment, when the door lock 102 is in the engaged position (shown in FIG. 2), the door 242 cannot be opened from the exterior surface 244 of the door 242, and the ballistic door panel assembly 302 provides protection to occupants of a room from ballistic objects or projectiles.

The door lock described herein is configured to securely lock (i.e., prevent movement of) the door to which it is attached, and can be retrofitted to existing doors. The door lock can do coupled to, for example, but without limitation, interior and/or exterior doors in schools, office buildings, hotels, and homes. The door lock is usable generally as a “one-piece” assembly. That is, no external elements are needed to engage or activate the door lock. Moreover, the door lock is generally biased to the engaged position such that, if components of the door lock (e.g., pins) were to fail or become removed, the door lock would move to the engaged position, still keeping the door secured and any occupants of the room safe. The unlock mechanism of the door lock ensures that only people inside the locked room, or those who have access to the specific key, can transition the door lock from the engaged position to the disengaged position. This feature further protects the occupants of the room from external threats (e.g., intruders).

The systems and methods described herein are not limited to the specific embodiments described herein, but rather, components of the systems and/or steps of the methods may be utilized independently and separately from other components and/or steps described herein.

As used herein, an element or step recited in the singular and preceded with the word “a” or “an” should be understood as not excluding plural elements or steps, unless such exclusion is explicitly recited. Furthermore, references to “exemplary embodiments”, “some embodiments”, or “one embodiment” of the present disclosure are not intended to be interpreted as excluding the existence of additional embodiments that also incorporate the recited features.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other and examples are intended to be within the scope of the claims if they include structural elements that do not differ from the literal language of the claims, or if they include equivalent structural elements with insubstantial differences from the literal language of the claims.

What is claimed is:

1. A door lock comprising:
a base configured to be coupled to a door, the base comprising an angled top wall and a bottom wall, wherein the base has at least one channel defined therein extending from the top wall to the bottom wall; and
a lock bar moveably coupled to the base and comprising at least one rod having a first end coupled to the lock bar and a second end that extends into the at least one channel, the lock bar further comprising a top wall and an angled bottom wall, wherein the lock bar bottom wall is oriented at substantially the same angle as the base top wall such that the base top wall and lock bar bottom wall are substantially parallel to one another;
wherein the lock bar is moveable relative to the base from a first, disengaged position, in which the lock bar is spaced from the base, to a second, engaged position, in which the lock bar bottom wall engages the base top wall, and the second end of the at least one rod protrudes from the base bottom wall.

2. The door lock of claim 1, further comprising a mounting plate coupled to the base, wherein the mounting plate has a plurality of fastener openings defined therein for securing the door lock to the door.

3. The door lock of claim 1, wherein the base further comprises a pair of opposing side walls, and wherein the base has at least one pocket defined therein that extends from a respective one of the side walls to the at least one channel.

4. The door lock of claim 3, further comprising at least one pin positioned within the at least one channel and comprising a first end that extends into the at least one channel, wherein the first end of the at least one pin is configured to contact the second end of the at least one rod to inhibit downward movement of the at least one rod through the at least one channel and to maintain the lock bar in the first, disengaged position.

5. The door lock of claim 4, wherein the second end of the at least one rod has a conical exterior surface, and wherein the first end of the at least one pin comprises a ball detent.

6. The door lock of claim 1, further comprising a foot plate extension extending outward from the lock bar, wherein the foot plate extension includes a top wall coplanar with a top wall of the lock bar such that the top walls of the foot plate extension and the lock bar define a flat strike surface.

7. The door lock of claim 1, further comprising a floor plate configured to be coupled to a floor adjacent to the door, the floor plate including at least one rod aperture defined therein and aligned with the at least one channel of the base,
wherein, in the second, engaged position, the at least one rod extends through the at least one aperture of the floor plate and into the floor.

8. The door lock of claim 1, further comprising a conveyor mechanism that permits relative movement of the lock bar with respect to the base, the conveyor mechanism comprising a conveyor shaft extending through the base, a toothed rack coupled to the lock bar, and a gear coupled to and co-axial with the conveyor shaft and rotatable with respect to the rack,
wherein vertical movement of the lock bar causes corresponding movement of the toothed rack and corresponding rotational movement of the gear.

9. The door lock of claim 8, further comprising an unlock mechanism comprising a key shaft coupled to and co-axial with the conveyor shaft, wherein rotation of the key shaft causes corresponding rotation of the conveyor shaft and the gear, and corresponding vertical movement of the rack to vertically translate the lock bar.

10. The door lock of claim 9, wherein the key shaft comprises a first end coupled to the conveyor shaft and a second end that, when coupled to the door, extends through the door to an exterior surface of the door.

11. The door lock of claim 8, wherein the base has a cavity defined therein, and wherein at least a portion of the conveyor mechanism is housed within the cavity.

12. The door lock of claim 1, wherein the lock bar is configured to,
upon application of an external upward force thereon, transition from the second, engaged position, to the first, disengaged position.

13. The door lock of claim 1, wherein the lock bar is biased, under the force of gravity, toward the second, engaged position.

14. The door lock of claim 1, further comprising at least one fastener extending through the lock bar to couple the at least one rod to the lock bar.

15. The door lock of claim 1, wherein the at least one rod comprises a first and a second rod, and wherein the at least one channel comprises a first and a second channel.

16. A ballistic door safety system comprising:
a ballistic panel assembly comprising a plurality of ballistic layers, the ballistic panel assembly configured to be coupled to a first surface of a door; and
a foot-activated door lock comprising:
a base configured to be coupled to the ballistic panel assembly, the base comprising an angled top wall and a bottom wall, wherein the base has at least one channel defined therein extending from the top wall to the bottom wall; and
a lock bar moveably coupled to the base and comprising at least one rod having a first end coupled to the lock bar and a second end that extends into the at least one channel, the lock bar further comprising a top wall and an angled bottom wall, wherein the lock bar bottom wall is oriented at substantially the same angle as the base top wall such that the base top wall and lock bar bottom wall are substantially parallel to one another;
wherein the lock bar is moveable relative to the base from a first, disengaged position, in which the lock bar is spaced from the base, to a second, engaged position, in which the lock bar bottom wall engages the base top wall, and the second end of the at least one rod protrudes from the base bottom wall.

17. The ballistic door safety system of claim 16, wherein the ballistic panel assembly comprises a first ballistic panel, a second ballistic panel, and a plurality of ballistic sheets interposed between the first and second panels.

18. The ballistic door safety system of claim 17, further comprising at least one fastener that couples the first and second panels to the door, wherein the fastener extends through the door from the first surface of the door to an opposing second surface of the door.

19. The ballistic door safety system of claim 17, wherein each of the first and second panels is constructed of extruded ultra-high molecular weight polyethylene, and wherein the plurality of ballistic sheets comprises a plurality of aramid fiber sheets.

20. The ballistic door safety system of claim 17, wherein each of the first and second panels has a thickness of between 0.125 inches and 0.5 inches, and wherein the plurality of ballistic sheets comprises between 10 and 20 aramid fiber sheets.
